(19) United States
(12) Patent Application Publication
(10) Pub. No.: US 2003/0186005 A1
(43) Pub. Date: Oct. 2, 2003

(54) APPLICATOR FOR A POLYMERIZABLE MONOMER COMPOUND

(76) Inventors: ANDRES RIVERA, RALEIGH, NC (US); KEITH R. D'ALESSIO, CARY, NC (US)

Correspondence Address: OLIFF & BERRIDGE, PLC, P.O. BOX 19928, ALEXANDRIA, VA, 22320, US

(21) Appl. No.: 09/353,592

(22) Filed: Jul. 15, 1999

(51) Int. Cl. B32B 1/02

(52) U.S. Cl. 428/35.7

(57) ABSTRACT

An applicator for dispensing a polymerizable or cross-linkable material includes an outer container, an inner container disposed within the outer container and containing a polymerizable or cross-linkable material, and a rate modifier for the polymerizable or cross-linkable material coated on an outer surface of the inner container. The rate modifier modifies a polymerization or cross-linking rate when the polymerizable or cross-linkable monomer material contacts the rate modifier upon opening of the inner container. The polymerizable and/or cross-linkable material may be applied to a variety of substrates.

### BACKGROUND OF THE INVENTION

1. Field of Invention

This invention relates to the polymerization and/or cross-linking of polymerizable and/or cross-linkable material. This invention also relates to the application of polymerizable and/or cross-linkable material to various substrates with an application device.

2. Description of Related Art

The terms polymerized and polymerizable, as they are used in the present application, encompass the terms cross-linkable/cross-linked and grafted/graftable as they are defined in the art. For example, not only does the term polymerization include the combination of monomers and prepolymers to form oligomers and polymers, it also includes the attachment of oligomers and polymers by various bridging constituents (cross-linking) and the attachment to oligomers and polymers of side chains having various atomic constituents (grafting).

In some applications, the physical properties of polymerized and/or cross-linked material are extremely important. For example, fast-acting surgical adhesives, sealants, bioactive agent release matrixes and implants utilized in medical, surgical and other in vivo applications require close control of the polymerized and/or cross-linked material. These materials include, for example, alpha-cyanoacrylates disclosed in U.S. Pat. Nos. 5,328,687 to Leung et al., 3,527,841 to Wicker et al., 3,722,599 to Robertson, 3,995,641 to Kronenthal et al., 3,940,362 to Overhults and U.S. patent application Ser. No. 08/266,647.

Typically, when used as adhesives and sealants, cyanoacrylates are applied in monomeric form to the surfaces to be joined or sealed, where, typically, in situ anionic polymerization of the monomer occurs, giving rise to the desired adhesive bond or seal. Implants, such as rods, meshes, screws, and plates, may be formed of cyanoacrylate polymers, formed typically by radical-initiated polymerization.

Efforts to increase the tissue compatibility of alpha-cyanoacrylates have included modifying the alkyl ester group of the cyanoacrylates. For example, increasing the alkyl ester chain length to form the higher cyanoacrylate analogs, e.g., butyl-2-cyanoacrylates and octyl-2-cyanoacrylates, has been found to improve biocompatibility, but the higher analogs biodegrade at slower rates than the lower alkyl cyanoacrylates.

Other examples of modified alpha-cyanoacrylates used in biomedical applications include carbalkoxyalkyl, alpha-cyanoacrylates (see, for example, U.S. Pat. No. 3,995,641 to Kronenthal et al.), fluorocyanoacrylates (see, for example, U.S. Pat. No. 3,722,599 to Robertson et al.), and alkoxyalkyl 2-cyanoacrylates (see, for example, U.S. Pat. No. 3,559,652 to Banitt et al.). Other efforts have included mixing alpha-cyanoacrylates with dimethyl methylenemalonate and higher esters of 2-cyanoacrylic acid (see, for example, U.S. Pat. No. 3,591,676 to Hawkins et al.).

In other efforts to increase the usefulness of alpha-cyanoacrylate adhesive compositions for surgical applications, certain viscosity modifiers have been used in combination with alkyl alpha-cyanoacrylate monomers, such as methyl alpha-cyanoacrylate. See, for example, U.S. Pat. Nos. 3,564,078 (wherein the viscosity modifier is poly(ethyl 2-cyanoacrylate)) and 3,527,841 (wherein the viscosity modifier is poly(lactic acid)).

In U.S. Pat. No. 5,328,687 to Leung et al., the use of formaldehyde scavengers has been proposed to improve biocompatibility of the alpha-cyanoacrylate polymers, whose biodegradation produces formaldehyde, for use in in vivo applications. Additionally, in U.S. application Ser. No. 08/266,647, the biodegradation rate of alpha-cyanoacrylate polymer is accomplished by regulating the pH of an immediate in vivo environment of a biocompatible composition. It is also known that various compounds can affect polymerization of alpha-cyanoacrylate monomers, including acids to inhibit or slow polymerization (e.g., U.S. Pat. No. 3,896,077 to Leonard et al.), and bases to accelerate polymerization (e.g., U.S. Pat. No. 3,759,264 to Coover and U.S. Pat. No. 4,042,442 to Dombroski et al.).

Likewise, many polymerization and/or cross-linking inhibitors are conventionally added to polymerizable and/or cross-linkable materials in order to increase their shelf life. However, the amount of polymerization inhibitor that may be added to the polymerizable and/or cross-linkable material is limited due to the negative impact on any subsequent polymerization process. In particular, a large quantity or concentration of polymerization inhibitor that is added to stabilize polymerizable and/or cross-linkable material may stabilize the polymerizable and/or cross-linkable material to an extent that will adversely affect polymerization. Accordingly, conventional polymerizable and/or cross-linkable materials may contain only a limited amount of polymerization inhibitor.

For certain applications of polymerizable and/or cross-linkable material there exists a need for controlling the setting time of the polymerizable and/or cross-linkable material. For example, surgical adhesives used for some surgical procedures require rapidly or relatively less rapidly setting materials, depending on the procedure involved (e.g., U.S. Pat. No. 5,328,687 to Leung et al. and U.S. application Ser. No. 08/266,647, the disclosures of which are incorporated herein by reference). Other bonding processes, including sealing and bonding processes in the construction and automotive industries, molding processes in the plastic industry, and coating processes in the textile and electronics industries, require a variety of setting times. Many of these applications require control of the setting time in order to facilitate adequate strength, elasticity and hardness of a polymerized material while also providing the necessary amount of working time to apply the polymerized material to a desired substrate.

Various dispensing devices have been developed for the purposes of applying and mixing multiple components simultaneously. For example, U.S. Pat. No. 3,468,548 to Leigh discloses a dispenser for dispensing two paste-like materials, such as creams or gels. One of the materials is stored in a tube and a second material is stored in a chamber of a nozzle attached to the tube. When the first material is forced from the tube, it flows through the nozzle and mixes with the second material.

U.S. Pat. No. 3,891,125 to Morane et al. describes a device for storing two products separately and mixing the products prior to application. One product is stored in a nozzle attached to a container containing a second product. The product in the nozzle drops by the force of gravity into the container containing the second product and mixing occurs. Subsequently, the mixed products may be forced from the container and applied to a suitable substrate.

U.S. Pat. No. 3,770,523 to Biswas relates the application of a thickened slurry explosive into a bore hole or a container. A stream of slurry explosive is thickened by admixing the stream with a cross-linking agent by a plurality of jet streams impinging on the slurry stream.

U.S. Pat. No. 4,801,008 to Rich discloses a disposable cartridge including a chamber containing a plurality of inter-reacting components of an adhesive system. The components are separated from each other by a barrier film. They are expelled through a nozzle where they are mixed with a static mixing element.

International Application No. PCT/US96/09575 to Closure Medical Corporation, published as International Publication No. WO 96/40797, discloses an applicator tip for dispensing a polymerizable and/or cross-linkable material. The applicator tip is porous and absorbent or adsorbent, and includes a polymerization or cross-linking initiator, which initiates polymerization or cross-linking of the polymerizable and/or cross-linkable material while it is being dispensed through the applicator tip. The reference also discloses that the polymerization or cross-linking initiator can be coated on an interior surface of the applicator in the case where the polymerizable and/or cross-linkable material is contained in a frangible vial within the applicator.

U.S. Pat. No. 3,913,733 to Flesch et al. discloses a cartridge containing a frangible ampoule and a two-component adhesive. A first component of the adhesive is accommodated in the ampoule, and a second component of the adhesive is externally adjacent the ampoule and so arranged as to be intermixable with the first component upon breakage of the ampoule. One of the components may be in the form of a paste and applied to the outer wall of the ampoule in the form of a helical strip or the like, or may be in the form of a layer or coating which is provided around the wall of the ampoule. The ampoule is covered by an outer envelope to prevent drying out, removal, damage or the like to the second component disposed on the exterior of the ampoule.

U.S. Pat. No. 5,256,723 to Hense et al. discloses a two-chamber cartridge for fastening anchor rods. One chamber of the cartridge contains a polymerizable, curable compound and the other chamber contains a polymerization and/or curing reaction initiator. FIG. 5 of the patent discloses the cartridge wherein the reaction initiator is within a first chamber, which is separated from a second chamber containing the polymerizable compound. The polymerizable material is suitable for bore hole filling masses, such as cycloaliphatic compounds. The polymerizable material can include other components that are suitable for this application such as accelerators, stabilizers, viscosity modifiers, fillers, thixotropizing agents and/or other polymerizable compounds.

U.S. Pat. No. 5,763,026 to Makino et al. discloses anchor-fixing capsules comprising a crushable capsule holding a hardenable resin component and a hardening agent. A separator layer is formed between the hardenable resin component and the hardening agent by a reaction product of the two. However, once the layer is formed, further hardening of the hardenable resin component does not occur until the respective components are further mixed together by breaking the separator layer. This reaction mechanism indicates that the hardening agent is different from a rate modifier, such as a polymerization or cross-linking initiator, because the hardenable material does not appear to be polymerization or cross-linking initiated by the hardening agent. Similar devices are also disclosed in European Patent No. 535,411.

Japanese Patent Unexamined Application No. 63-142199 discloses a masonry anchor bolt. The anchor bolt includes a tubular, cylindrical capsule, made from glass or ceramic, which contains a hardenable synthetic resin. At the trail end of the capsule and in a separate chamber or cap is located a hardening agent, which mixes with the resin when an anchor bolt is driven into the capsule.

Japanese Patent Unexamined Application No. 5-171695 discloses a resin capsule anchor. The anchor comprises a crushable cylindrical glass vessel containing a curable resin. A recessed section is formed in the external surface of the vessel, into which is placed a curing agent for the resin.

### SUMMARY OF THE INVENTION

The need continues to exist in the polymer and resin and coating industries for improved processes for controlling the properties of polymerized materials by controlling the polymerization and/or cross-linking rate and/or extent. Moreover, there is a need to provide a simplified and economical process for applying polymerizable and/or cross-linkable materials to various substrates. The present invention provides an inexpensive device and method that simplify the application of a variety of polymerizable and/or cross-linkable materials to substrates while providing control over the properties of the material, especially fast-curing materials and medicinal use materials.

This invention provides an applicator for dispensing a polymerizable or cross-linkable material, comprising:

an outer container;

an inner container disposed within said outer container, said inner container containing a polymerizable or cross-linkable material; and

a rate modifier for said polymerizable or cross-linkable material disposed on an outer surface of said inner container.

The present invention also provides a method for making such an applicator, as well as a method for using the applicator.

The applicator according to the present invention provides several advantages, including the ability to:

a) control the molecular weight of the polymerized or cross-linked material;

b) control the setting time of the polymerized or cross-linked material;

c) provide precision and convenience in applying the material to a substrate;

d) extend the material shelf life;

e) reduce the presence of residual monomer and avoid associated monomer odors; and

f) control the flow properties of applied materials.

The applicator of the present invention may be used to apply to various substrates a wide variety of monomers and polymers that undergo polymerization and/or cross-linking by utilization of a polymerization or cross-linking rate modifier. Moreover, the applicator of the present invention may be utilized in a wide variety of monomer and polymer systems, such as, for example, in the application of plural component adhesive systems.

### BRIEF DESCRIPTION OF THE DRAWINGS

FIG. 1 is a side elevational view of an applicator device in accordance with this invention for application of a polymerizable and/or cross-linkable material.

### DETAILED DESCRIPTION OF PREFERRED EMBODIMENTS

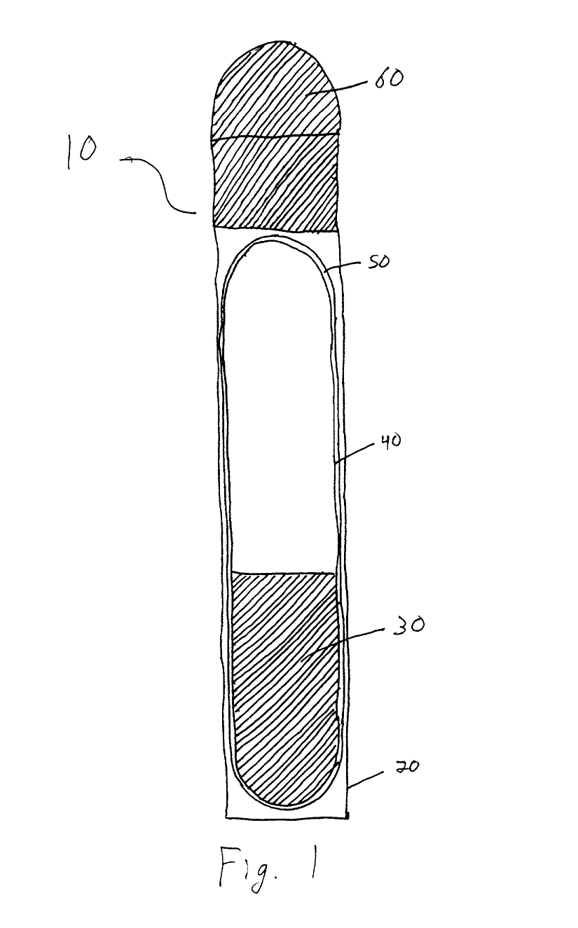

An applicator device embodying one aspect of the present invention is generally shown in the FIGURE as applicator device 10. The device comprises a cylindrical applicator container 20 holding a polymerizable or cross-linkable monomer material 30 enclosed in a frangible vial 40, and an applicator tip 60. Furthermore, the applicator 10 includes a polymerization or cross-linking rate modifier 50 lined or coated on the outer surface of the frangible vial 40. As shown in FIG. 1, the frangible vial 40 is preferably only partially filled with the polymerizable or cross-linkable monomer material 30.

As will be described in greater detail below, “rate modifier” is meant to encompass such compounds as have a measurable effect upon the rate of polymerization or cross-linking of a polymerizable or cross-linkable monomer material. Thus, as used herein, “rate modifier” is meant to encompass polymerization and cross-linking initiators and accelerators, as well as polymerization and cross-linking inhibitors.

The applicator according to the present invention may be in a variety of shapes and sizes depending on the intended use. For example, for application of limited amounts of polymerizable and/or cross-linkable material, the applicator may be a syringe, a tube, a vial, a bulb or a pipette. For example, a frangible closed ampoule or vial of polymerizable and/or cross-linkable material in a flexible container as shown in FIG. 1 is a preferred type of applicator. For applications of the polymerizable and/or cross-linkable material in greater amounts, applicator containers such as, for example, tanks or reactor vessels may be utilized so long as they conform to the present invention.

According to the present invention, the frangible vial has an outer diameter that is smaller than the inner diameter of the applicator body. There must be at least enough clearance between the inner wall of the applicator body and the outer wall of the vial, to allow for the coating layer of the rate modifier on the outer surface of the vial. Of course, the clearance need not be extremely tight, and the present invention instead encompasses embodiments where the frangible vial has a significantly smaller outer diameter than the inner diameter of the applicator tube.

Furthermore, in embodiments, it is preferred that any excess space within the applicator body but outside of the frangible vial be left open, and not be filled with materials such as fillers and the like. Such excess space permits added mixing area for the rate modifier and the polymerizable or cross-linkable material upon breaking of the vial, thereby providing improved operation of the applicator. In such embodiments, a discrete amount of the rate modifier is applied to the vial, and does not substantially fill a remaining area in the applicator body.

The applicator tip may also have a variety of suitable shapes, including but not limited to conical, cylindrical, chisel or polygonal shapes. For example, the tip may be a tube, cannula, catheter, single or multi-lumen shape, or comprise a rolling ball, brush, cotton swab or similar tip. Preferably, the applicator tip is conical or semi-spherical. The end having decreased circumference is preferably the end from which the material exits from the applicator and is fashioned in a manner to facilitate application of the material to any suitable substrate. The length of the applicator tip may also be varied depending on various application parameters, such as the proximity of the applicator container holding the polymerizable and/or cross-linkable material to the substrate to which the material is to be applied. The size of the tip end in which the material exits the tip may be varied depending on the application.

The applicator tip in embodiments of the present invention may be detachable from the applicator container holding the polymerizable and/or cross-linkable material. Such an applicator tip could be attached to the applicator container prior to use and detached from the applicator container subsequent to use. Additionally, the applicator tip may comprise multiple parts, or may be fabricated as a single part.

The applicator tip may also be in the form of a nozzle for atomizing liquid polymerizable and/or cross-linkable materials. Conical, flat spray or condensed stream nozzles are suitable.

The applicator tip and the applicator container may also be an integral unit. The unit may be preformed as a single piece and charged with polymerizable and/or cross-linkable material. After application of material 30 from the applicator container, the unit may be discarded. Additionally, such an integral applicator tip/applicator container unit may be fashioned to provide the capability of recharging the unit with new material as a multiple use device.

The applicator may be utilized in manual or automated applications. For example, manual methods of application may include utilization of hand-held devices such as syringes, adhesive guns, pipettes, eyedroppers and the like. Automated application processes include injection molding and robotic painting/sealing/adhering.

Furthermore, although according to the present invention the polymerization or cross-linking rate modifier for the polymerizable or cross-linkable monomer material is disposed on an outer surface of a frangible vial contained within the applicator body, it is also possible to incorporate an amount of polymerization or cross-linking rate modifier into the applicator tip. Such an embodiment, for example, will assist in ensuring that after the frangible vial is broken, the enclosed polymerizable or cross-linkable monomer material is contacted with a sufficient amount of the rate modifier within the applicator such that the rate modifier begins to affect the polymerizable or cross-linkable monomer material, after which further contact, and thus further effect, occurs when the polymerizable or cross-linkable monomer material is applied through the applicator tip. Thus, for example, in the case of the rate modifier being a polymerization initiator, contact with the rate modifier within the applicator will cause at least pre-initiation of the polymerizable monomer material, which initiation is then accelerated by contact with further initiator in the applicator tip.

The applicator tip may be composed of any of a variety of materials including polymerized materials such as plastics, foams, rubber, thermosets, films or membranes. Additionally, the applicator tip may be composed of materials such as metal, glass, paper, ceramics, cardboard and the like. The applicator tip material may be porous, absorbent or adsorbent in nature to enhance and facilitate loading of a quantity of rate modifier or other materials on or within the applicator tip. For example, the applicator tip may be composed of a material having random pores, a honey-comb material, a material having a woven pattern, etc. The degree of porosity will depend on the materials being used.

The applicator tip, where it connects to the applicator container, may have an elongated tubular portion, out of which the mixed polymerizing and/or cross-linking material is expelled. A portion of the applicator tip that is immediately downstream of the applicator container is advantageously porous in order to avoid a sharp pressure drop and ensure a constant mixed ratio profile. The structure can preferably trap any barriers or materials used to separate multiple components within the applicator container, such as fragments of the frangible vial. Thus, any such barriers will not clog the device.

According to the present invention, the rate modifier is lined or coated on the outer surface of the frangible vial, which contains the polymerizable or cross-linkable material, such that the rate modifier is in a non-contacting relationship with the polymerizable or cross-linkable material prior to breaking the frangible vial. In embodiments, the rate modifier can be applied to an entire outer surface of the frangible vial, or it can be applied to only a portion of the outer surface of the vial. However, the rate modifier should preferably cover a sufficient portion of the outer surface of the frangible vial to ensure that, upon breaking of the vial, there is sufficient contact between the polymerizable or cross-linkable material and the rate modifier so as to sufficiently modify (i.e., initiate, accelerate, inhibit, etc.) polymerization or cross-linking. Furthermore, if desired, additional quantities of the rate modifier can be applied in or on the applicator tip, or can be applied to part or all of the inner surface of the applicator container body, although such additional rate modifier is not necessary in embodiments of the present invention.

When additional rate modifier is applied in or on the applicator tip, it may be applied to a surface portion or to the entire surface of the applicator tip, including the interior and the exterior of the tip. Alternatively, the initiator may be coated on an internal surface of the applicator tip. Preferably, only a portion of the interior of the applicator tip is coated with the initiator.

The rate modifier applied to the outer surface of the frangible vial, as well as to any other portions of the applicator, may be in the form of a solid, such as a powder or a solid film, or in the form of a liquid, such as a viscous or paste-like material. In embodiments, the rate modifier may also be physically or chemically attached to the outer surface of the frangible vial, such as by being embedded in or chemically attached (bonded) to the outer surface of the frangible vial. When the inner container (frangible vial) has an open end that is to be flame sealed, it is preferred that the rate modifier is coated on the vial at a location away from the open end, such as at the other end of the container. The rate modifier may also include a variety of additives, such as surfactants or emulsifiers. Preferably, the rate modifier is soluble in the polymerizable and/or cross-linkable material, and/or comprises or is accompanied by at least one surfactant which, in embodiments, helps the rate modifier co-elute with the polymerizable and/or cross-linkable material. In embodiments, the surfactant may help solubilize the rate modifier in the polymerizable and/or cross-linkable material.

Particular rate modifiers for particular monomers may be readily selected by one of skill in the art without undue experimentation. Control of the molecular weight distribution of the applied adhesive can be enhanced by selection of the concentration and functionality of the rate modifier vis-a-vis the selected monomer and the desired effect (initiation, acceleration, or inhibition) that the rate modifier is to have. Suitable polymerization initiators and rate modifiers for cyanoacrylate compositions include, but are not limited to, detergent compositions; surfactants, including nonionic surfactants such as polysorbate 20 (e.g., Tween 20™; ICI Americas), polysorbate 80 (e.g., Tween 80198 ; ICI Americas), and poloxamers; cationic surfactants such as tetrabutylammonium bromide; anionic surfactants, including quaternary ammonium halides such as benzalkonium chloride or its pure components, and benzethonium chloride; stannous octoate (tin (II) 2-ethylhexanoate), and sodium tetradecyl sulfate; and amphoteric or zwitterionic surfactants such as dodecyldimethyl(3-sulfopropyl) ammonium hydroxide, inner salt; amines, imines, and amides, such as imidazole, tryptamine, urea, arginine and povidine; phosphines, phosphites and phosphonium salts, such as triphenylphosphine and triethyl phosphite; alcohols such as ethylene glycol; methyl gallate; ascorbic acid; tannins and tannic acid; inorganic bases and salts, such as sodium bisulfite, magnesium hydroxide, calcium sulfate and sodium silicate; sulfur compounds such as thiourea and polysulfides; polymeric cyclic ethers such as monensin, nonactin, crown ethers, calixarenes and polymeric epoxides; cyclic and acyclic carbonates, such as diethyl carbonate; phase transfer catalysts such as Aliquat™ 336 (General Mills, Inc., Minneapolis, Minn.); organometallics; manganese acetylacetonate; radical initiators and radicals, such as di-t-butyl peroxide and azobisisobutyronitrile; and bioactive compounds or agents.

In preferred embodiments, the rate modifier may be a bioactive material, including quaternary ammonium halides such as alkylbenzyldimethylammonium chloride (benzalkonium chloride; BAC) its pure components, or mixtures thereof, especially those with an alkyl containing 6-18 carbon atoms; benzethonium chloride; and salts of sulfadiazine. Cobalt napthenate can be used as an accelerator for peroxide.

The polymerizable and/or cross-linkable material may also contain an initiator and/or a rate modifier that is inactive until activated by a catalyst or accelerator (also included within the scope of the term “rate modifier” as used herein) coated on the outside of the frangible vial. Initiators activated by stimulation such as heat and/or light (e.g., ultraviolet or visible light) are also suitable if the tip and/or applicator is appropriately subjected to such stimulation.

In addition, in embodiments, the rate modifier can be a polymerization or cross-linking inhibitor. For example, suitable cyanoacrylate polymerization inhibitors or stabilizers include, but are not limited to, Lewis acids, such as sulfur dioxide, nitric oxide, boron trifluoride, and other acidic substances, including hydroquinone monomethyl ether, hydroquinone, nitrohydroquinone, catechol, and hydroquinone monoethyl ether, mixtures thereof and the like. Such inhibitors are disclosed in, for example, U.S. Pat. No. 3,559,652 to Banitt, the entire disclosure of which is incorporated herein by reference. The addition of these inhibitors and stabilizers inhibits premature polymerization of the monomer and slows down the rate of polymerization once the composition is in contact with the surface to be treated.

According to the present invention, the rate modifier is selected based primarily on the type of polymerizable or cross-linkable material contained within the frangible vial. For example, the rate modifier is selected to be compatible with and effective upon the polymerizable or cross-linkable material. Furthermore, the rate modifier should be selected based on its relative effective rate in accordance with the particular use to be made of the adhesive composition. For example, if it is desired that the adhesive not polymerize or cross-link very quickly, a slower acting rate modifier may be selected. In contrast, if quick polymerization or cross-linking is desired, a faster acting rate modifier may be selected.

In addition, it is also important to control the amount of rate modifier incorporated into the applicator. For example, it is necessary to incorporate at least an effective amount of the rate modifier into the applicator, such as on the outer surface of the frangible vial, so that upon breaking the frangible vial there is sufficient contact between the polymerizable or cross-linkable material and the rate modifier for the rate modifier to serve its intended purpose. However, there should not be so much rate modifier present as to overly modify the rate and prevent operation of the applicator. For example, in the case of the rate modifier being an initiator, there should not be so much initiator present as to fully polymerize or cross-link the polymerizable or cross-linkable material within the applicator, thereby clogging the applicator. Furthermore, it is preferred in embodiments that the rate modifier not completely fill a space between the frangible vial and the applicator walls, such as by being at most only coated on the outer surface of the frangible vial, so as to permit space within the applicator for the polymerizable or cross-linkable material and the rate modifier to mix.

The rate modifier may be applied to the outer surface of the frangible vial or, in embodiments, may be impregnated or incorporated into the surface layer of the outer surface of the frangible vial. For example, the rate modifier may be applied to the frangible vial by spraying, dipping, or brushing the frangible vial with a liquid or paste medium containing the rate modifier. Where a liquid medium is used, the liquid medium may include non-aqueous solvents, such as ether, acetone, ethanol, pentane or mixtures thereof; or may include aqueous solutions. Preferably, the liquid medium is a low boiling point solvent.

The rate modifier may also be applied to the frangible vial in the form of a preformed film composed of or containing the rate modifier. The rate modifier may be applied as a solid by vapor deposition such as by sputtering. Additionally, the rate modifier may be incorporated into the frangible vial, preferably only in an outermost layer of the frangible vial so as to prevent premature contact of the rate modifier with the polymerizable or cross-linkable material, for example, during the fabrication of the vial, such as by molding or extrusion.

Subsequent to application of the initiator on the frangible vial, the frangible vial may be dried or heated to evaporate or volatilize the liquid medium or to evenly distribute the rate modifier on the frangible vial. This can be accomplished by drying the frangible vial at room temperature or by heating the applicator in a conventional device such as a conventional oven, vacuum oven, microwave oven, or UV/visible light.

Within the applicator tip, static or dynamic mixers may be provided to ensure thorough mixing of the polymerizable and/or cross-linkable material with the rate modifier as both components pass through the applicator tip. Preferable static mixers include internal tortuous paths.

The applicator according to the present invention may also be utilized in conjunction with multi-component polymerizable and/or cross-linkable material systems having materials that must remain physically separated from each other prior to application in order to avoid chemical reactions therebetween. Such multi-component cartridges, for instance, are disclosed in U.S. Pat. Nos. 3,915,297 to Rausch, 4,493,436, 4,538,920 and 4,801,008 to Rich, the entire disclosures of which are incorporated herein by reference.

In operation, the frangible vial is broken or opened, such as through the application of pressure to the frangible vial through the applicator container. Once the frangible vial is opened, the polymerizable material contained in the vial escapes into the remainder of the applicator container body, where it contacts the rate modifier that is coated on the outer surface of the vial. As the polymerizable and/or cross-linkable material mixes with the rate modifier in the applicator container body, the polymerization or cross-linking rate of the material is affected. Pressure may then be applied to the applicator container body, to force the material from the applicator container through the applicator tip.

The shape of the applicator tip preferably enhances mixing of the material and the rate modifier to provide a homogeneous mixture. The shape of the applicator tip also facilitates application of the polymerizing and/or cross-linking material to a suitable substrate. The rate modifier may co-elute with the polymerizable and/or cross-linkable material, or may remain in the applicator container and/or applicator tip.

The applicator of the present invention may be employed in a variety of processes for the application of a variety of polymerizable and/or cross-linkable materials. In particular, the polymerizable and/or cross-linkable materials include natural, synthetic, and semi-synthetic materials, including inorganic and organic materials, and combinations thereof.

Suitable inorganic materials include but are not limited to siloxanes, silicones, polysulfides and polyphosphazenes. Suitable organic polymerizable and/or cross-linkable materials include but are not limited to natural, synthetic, and semi-synthetic materials. Suitable natural polymerizable and/or cross-linkable materials include but are not limited to polysaccharides, such as starch, cellulose, pectin, seaweed gums or vegetable gums; polypeptides or proteins, such as casein, albumin, globulin, or carotin; or hydrocarbons, such as rubber and polyisoprene.

Suitable organic synthetic materials include but are not limited to thermoplastics and thermoplastic elastomers, such as nylon and other polyamides, polyvinylchloride, polycarbonates, polyethylene, polystyrene, polypropylene, fluorocarbon resins, polyurethane and acrylate resins; or thermosetting elastomers, such as phenolics, urethanes, epoxies, alkyds or polyesters. Suitable organic semi-synthetic materials include but are not limited to celluloses, such as rayon, methylcellulose, or cellulose acetate; or modified starches, such as starch acetate, and the like.

Examples of suitable polymerizable and/or cross-linkable materials include but are not limited to those set forth in U.S. Pat. Nos. 5,328,687 to Leung et al., 3,728,375 to Coover, Jr., et al., 3,970,505 to Hauser et al., 4,297,160 to Kusayama et al., 4,340,708 to Gruber, 4,777,230 to Kamath, 5,130,369 to Hughes et al. and U.S. applications Ser. Nos. 08/226,647 and 09/099,457, the entire disclosures of which are incorporated herein by reference. The polymerizable and/or cross-linkable material may include one of the above-mentioned materials or may contain one or more of the materials in a mixture. The material may also be composed of monomers, polymers, or oligomers of the above-mentioned polymerizable and/or cross-linkable materials.

For example, suitable polymerizable and/or cross-linkable materials include 1,1-disubstituted ethylene monomers. Useful 1,1-disubstituted ethylene monomers include, but are not limited to, monomers of the formula:

CHR═CXY (I)

wherein X and Y are each strong electron withdrawing groups, and R is H, —CH═CH2 or, provided that X and Y are both cyano groups, a C₁-C₄ alkyl group.

Examples of monomers within the scope of formula (I) include alpha-cyanoacrylates, vinylidene cyanides, C₁-C₄ alkyl homologues of vinylidene cyanides, dialkyl 2-methylene malonates, acylacrylonitriles, vinyl sulfinates and vinyl sulfonates of the formula CH₂═CX′Y′ wherein X′ is —SO₂R′ or —SO₃R′ and Y′ is —CN, —COOR′, —COCH₃, —SO₂R′ or —SO₃R′, and R′ is H or hydrocarbyl.

Preferred monomers of formula (I) for use in this invention are alpha-cyanoacrylates. These monomers are known in the art and have the formula

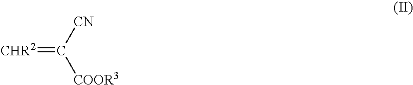

wherein R⁷ is hydrogen and R³ is a hydrocarbyl or substituted hydrocarbyl group; a group having the formula —R⁴—O—R⁵—O—R⁶, wherein R⁴ is a 1,2-alkylene group having 2-4 carbon atoms, R⁵ is an alkylene group having 2-4 carbon atoms, and R⁶ is an alkyl group having 1-6 carbon atoms; or a group having the formula

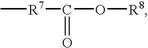

wherein R⁷ is

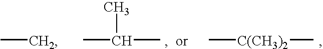

and R⁸ is an organic radical.

Examples of suitable hydrocarbyl and substituted hydrocarbyl groups include straight chain or branched chain alkyl groups having 1-16 carbon atoms; straight chain or branched chain C₁-C₁₆ alkyl groups substituted with an acyloxy group, a haloalkyl group, an alkoxy group, a halogen atom, a cyano group, or a haloalkyl group; straight chain or branched chain alkenyl groups having 2 to 16 carbon atoms; straight chain or branched chain alkynyl groups having 2 to 12 carbon atoms; cycloalkyl groups; aralkyl groups; alkylaryl groups; and aryl groups.

In the cyanoacrylate monomer of formula (II), R³ is preferably an alkyl group having 1-10 carbon atoms or a group having the formula —AOR⁹, wherein A is a divalent straight or branched chain alkylene or oxyalkylene radical having 2-8 carbon atoms, and R⁹ is a straight or branched alkyl radical having 1-8 carbon atoms.

Examples of groups represented by the formula —AOR⁹ include 1-methoxy-2-propyl, 2-butoxyethyl, 2-isopropoxyethyl, 2-methoxyethyl, 2-ethoxyethyl and 3-methoxybutyl.

Especially advantageous alpha-cyanoacrylate monomers for use in this invention are methyl alpha-cyanoacrylate, butyl alpha-cyanoacrylate, 2-octyl alpha-cyanoacrylate, 1-methoxy-2-propyl cyanoacrylate, 2butoxyethyl cyanoacrylate, 2-isopropoxyethyl cyanoacrylate and 3-methoxybutyl cyanoacrylate. Equally advantageous are 2-methylene malonates, such as dimethyl 2-methylenemalonate.

The alpha-cyanoacrylates of formula (II) wherein R³ is a hydrocarbyl or substituted hydrocarbyl group can be prepared according to methods known in the art. Reference is made, for example, to U.S. Pat. Nos. 2,721,858 and 3,254,111, each of which is hereby incorporated by reference herein. For example, the alpha-cyanoacrylates can be prepared by reacting an alkyl cyano-acetate with formaldehyde in a non-aqueous organic solvent and in the presence of a basic catalyst, followed by pyrolysis of the anhydrous intermediate polymer in the presence of a polymerization inhibitor. The alpha-cyanoacrylate monomers prepared with low moisture content and essentially free of impurities are preferred for biomedical use.

The alpha-cyanoacrylates of formula (II) wherein R³ is a group having the formula —R⁴—O—R⁵—O—R⁶ can be prepared according to the method disclosed in U.S. Pat. No. 4,364,876 (Kimura et al.), which is hereby incorporated by reference herein. In the Kimura et al. method, the alpha-cyanoacrylates are prepared by producing a cyanoacetate by esterifying cyanoacetic acid with an alcohol or by transesterifying an alkyl cyanoacetate and an alcohol; condensing the cyanoacetate and formaldehyde or paraformaldehyde in the presence of a catalyst at a molar ratio of 0.5-1.5:1, preferably 0.8-1.2:1, to obtain a condensate; depolymerizing the condensation reaction mixture either directly or after removal of the condensation catalyst to yield crude cyanoacrylate; and distilling the crude cyanoacrylate to form a high purity cyanoacrylate.

The alpha-cyanoacrylates of formula (II) wherein R³ is a group having the formula

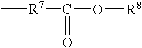

can be prepared according to the procedure described in U.S. Pat. No. 3,995,641 to Kronenthal et al., which is hereby incorporated by reference. In the Kronenthal et al. method, such alpha-cyanoacrylate monomers are prepared by reacting an alkyl ester of an alpha-cyanoacrylic acid with a cyclic 1,3-diene to form a Diels-Alder adduct which is then subjected to alkaline hydrolysis followed by acidification to form the corresponding alpha-cyanoacrylic acid adduct. The alpha-cyanoacrylic acid adduct is preferably esterified by an alkyl bromoacetate to yield the corresponding carbalkoxymethyl alpha-cyanoacrylate adduct. Alternatively, the alpha-cyanoacrylic acid adduct may be converted to the alpha-cyanoacrylyl halide adduct by reaction with thionyl chloride. The alpha-cyanoacrylyl halide adduct is then reacted with an alkyl hydroxyacetate or a methyl substituted alkyl hydroxyacetate to yield the corresponding carbalkoxymethyl alpha-cyanoacrylate adduct or carbalkoxy alkyl alpha-cyanoacrylate adduct, respectively. The cyclic 1,3-diene blocking group is finally removed and the carbalkoxy methyl alpha-cyanoacrylate adduct or the carbalkoxy alkyl alpha-cyanoacrylate adduct is converted into the corresponding carbalkoxy alkyl alpha-cyanoacrylate by heating the adduct in the presence of a slight deficit of maleic anhydride.

Examples of monomers of formula (II) include cyanopentadienoates and alpha-cyanoacrylates of the formula:

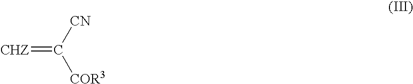

wherein Z is —CH═CH₂ and R³ is as defined above. The monomers of formula (III) wherein R³ is an alkyl group of 1-10 carbon atoms, i.e., the 2-cyanopenta-2,4-dienoic acid esters, can be prepared by reacting an appropriate 2-cyanoacetate with acrolein in the presence of a catalyst such as zinc chloride. This method of preparing 2-cyano-penta-2,4-dienoic acid esters is disclosed, for example, in U.S. Pat. No. 3,554,990, which is incorporated by reference herein.

Furthermore, additional polymerizable and/or cross-linkable materials suitable for use in the present invention are disclosed in U.S. application Ser. No. 09/099,457, the entire disclosures of which is incorporated herein by reference.

The polymerizable and/or cross-linkable materials may include additives, such as polymerization inhibitors or stabilizers, viscosity modifiers, free radical scavengers, pH modifiers (e.g., U.S. application Ser. No. 08/266,647, the subject matter of which is incorporated herein by reference), other monomers, formaldehyde scavengers (e.g., U.S. Pat. No. 5,328,687 to Leung et al., the subject matter of which is incorporated herein by reference), colorants, lubricants, release or transfer agents, surfactants, defoamants, plasticizers, mixtures thereof and other additives.

The polymerizable and/or cross-linkable material may be neat (no additional compounds added) or in a solvent, emulsion or suspension. Suitable solvents according to the present invention include alcohol, ether alcohol, hydrocarbons, halogenated hydrocarbons, ethers, acetals, ketones, esters, acids, sulfur- or nitrogen-containing organic compounds, mixtures thereof and the like. Other suitable solvents are disclosed in U.S. Pat. No. 5,130,369 to Hughes et al. and U.S. Pat. No. 5,216,096 to Hattori et al., the entire disclosures of which are incorporated herein by reference. These solvents may be used either independently or in combination of two or more. They may also be used in conjunction with water to the extent that the polymerizable and/or cross-linkable material is dissolved or suspended in such a mixture. The total amount of solvent that may be incorporated into the polymerizable and/or cross-linkable material may be 0 to 99, preferably 1 to 50, and more preferably 3 to 25 percent by weight. Selection of the amount will, of course, depend on the desired monomer and process conditions, and amounts outside these ranges may be acceptable.

The polymerizable and/or cross-linkable material may also contain polymerization initiators, accelerators or inhibitors, chain transfer agents, stabilizers, or mixtures thereof. In embodiments where such additives are suitable in addition to the above-described rate modifier, such further additives may be included with the polymerizable and/or cross-linkable material inside the frangible vial, or they may be contained outside of the frangible vial. Suitable polymerization inhibitors and stabilizers are disclosed in U.S. Pat. Nos. 5,322,912 to Georges et al., 4,581,429 to Solomon et. al., 4,340,708 to Gruber, 4,364,876 to Kimura et al. and 4,297,160 to Kusayama et al. The entire disclosures of these patents are incorporated herein by reference. The stabilizer or inhibitor may be added to the polymerizable and/or cross-linkable material in an amount of 0 to 50, preferably 0.001 to 25, and more preferably 0.002 to 10 percent by weight. Selection of the amount will, of course, depend on the desired monomer and process conditions, and amounts outside these ranges may be acceptable.

Suitable chain transfer agents which may be incorporated into the polymerizable and/or cross-linkable material of the present invention include those disclosed in U.S. Pat. No. 5,130,369 to Hughes et al., the entire disclosure of which is incorporated herein by reference. The amount of chain transfer agent included in the polymerizable and/or cross-linkable material may be 0 to 25, preferably 1 to 15, and more preferably 2 to 10 percent by weight. Selection of the amount will, of course, depend on the desired monomer and process conditions, and amounts outside these ranges may be acceptable.

Suitable viscosity modifiers, plasticizers and lubricants, which may or may not themselves be polymerizable and/or cross-linkable, that may be added to the polymerizable and/or cross-linkable material of the subject invention include those set forth in U.S. Pat. No. 4,297,160 to Kusayama et al., the entire disclosure of which is incorporated herein by reference. The polymerizable and/or cross-linkable material according to the present invention may also contain formaldehyde scavengers and pH modifiers as disclosed in U.S. Pat. No. 5,328,687 to Leung et al. and U.S. application Ser. No. 08/266,647, respectively, the disclosures of which are totally incorporated herein by reference.

In further embodiments of the present invention, it is possible, and even preferred, to apply a layer of cured adhesive material to the inner and/or outer walls of the frangible vial. For example, this cured adhesive coating could be of the same material that would be formed by the polymerizable or cross-linkable material, or could be a different material. When applied to the outer surface of the frangible vial, the adhesive should preferably still permit contact between the rate modifier and the polymerizable or cross-linkable material when the vial is broken. Or, still further, the rate modifier can, for example, form free radical sites on the coated adhesive layer, which can then interact with the polymerizable or cross-linkable material when the vial is broken. A benefit of the adhesive layer being applied to the inner and/or outer surfaces of the vial is that it provides a protective layer over the surface of the crushable ampoule. The protective layer or barrier can thereby protect a user's hand from puncture with shards created during crushing of the vial, while being incorporated into the applicator in a convenient and economical manner. Further details of the adhesive layer are set forth in U.S. patent application Ser. No. 09/176,889, the entire disclosure of which is incorporated herein by reference.

The material according to the present invention may be applied to a variety of substrates for the purposes of protecting, sealing, and bonding surfaces together. Suitable substrates include metals, plastics, rubbers, wood, ceramics, fabrics, cement, paper, living tissue and the like. For example, the polymerizable and/or cross-linkable material may be useful as tissue adhesives, sealants for preventing bleeding or for covering open wounds, systems for delivery of therapeutic or other bioactive agents, and other biomedical applications. They find uses in, for example, closing surgically incised or traumatically lacerated tissues; setting fractured bone structures; retarding blood flow from wounds; aiding repair and regrowth of living tissues; providing implantable matrixes for delivering bioactive agents; dressing burns; dressing skin or other superficial or surface wounds (such as abrasions, chaffed or raw skin, and/or stomatitis); protecting tissues prone to damage (e.g., as artificial calluses); and providing structural implants.

As described briefly above, the present invention provides significant advantages over the prior art. The applicator according to the present invention provides control over the molecular weight of the polymerized or cross-linked material. For example, the amount of rate modifier applied to the frangible vial may be increased to an extent that would provide more complete polymerization or cross-linking of a polymerizable and/or cross-linkable material over conventional methods that incorporate the rate modifier in the polymerizable and/or cross-linkable material before application thereof.

The applicator according to the present invention also provides control over the setting time of the material. For example, the amount of rate modifier applied to the frangible vial may be varied from one vial to another in order to provide control over the length of working time for application of a material.

The applicator according to the present invention also provides extended shelf life of the polymerizable and/or cross-linkable material. For example, by providing an increased amount of rate modifier on the outer surface of the frangible vial, the polymerizable and/or cross-linkable material within the frangible vial may be provided with a greater amount of polymerization inhibitors or stabilizers that would decrease premature polymerization. The applicator according to the present invention also provides increased ease of application of the polymerizable and/or cross-linkable material by providing improved rheological properties of this material during application to a substrate. For example, surfactants incorporated with the rate modifier on the frangible vial and/or in the applicator tip can provide the polymerizing material exiting the applicator tip with enhanced fluidity, and can assist the rate modifier to co-elute with the material.

The following examples illustrate specific embodiments of the present invention. One skilled in the art will recognize that the appropriate reaction parameters, reagents, component ratios/concentrations and device dimensions may be adjusted as necessary to achieve specific polymerized product characteristics. All parts and percentages are by weight unless otherwise indicated.

### EXAMPLES 1-6

An initiators as a rate modifier is coated upon the outer surface of glass ampoules containing stabilized polymerizable cyanoacrylate monomer material. For these Examples, Tween 20 (polysorbate 20 available from ICI Americas) as an initiator is coated on the outside of separate ampoules containing stabilized polymerizable cyanoacrylate monomer material. The initiator is coated on the ampoules by dropping the ampoules into a beaker containing Tween 20 and allowing them to sit for fifteen minutes. The coated ampoules are then removed and transferred inside butyrate tubes.

Porous plastic tips of applicators as shown in FIG. 1 are attached to the open end of flexible butyrate tubes containing the glass-ampoulized monomer material, generally as shown in FIG. 1. The tips are attached to the butyrate tubes using acetone, which solvent bonds the tips to the tubes. (The butyrate tubes soften upon contact with acetone that may be included in the tips, thus “welding” the tip to the applicator body.) The applicators are allowed to dry for thirty minutes to allow the acetone to set up.

In an upright position, the applicator tubes are squeezed to shatter the glass ampoules, thereby releasing monomer material to mix with the initiator coated on the outer surface of the ampoule. The applicators are then inverted, and the monomer material is forced out of the tip by squeezing the applicator tube. As the material comes out of the tubes, the material is dropped onto an aluminum pan that contains a thermocouple probe, connected to a data acquisition system. The temperature of the polymerizing material is monitored, and the maximum temperature is taken as the setting time of the adhesive. The results are shown in Table 1, and demonstrate the effectiveness of the claimed invention in controlling polymerization time.

TABLE 1

| | Setting Time |
|---|---|
| Example | (seconds) |
| 1 | 10.7 |
| 2 | 11.3 |
| 3 | 5.2 |
| 4 | 8.6 |
| 5 | 21.1 |
| 6 | 13.4 |

What is claimed is:

1. An applicator for dispensing a polymerizable or cross-linkable material, comprising:
an outer container;
an inner container disposed within said outer container, said inner container containing a polymerizable or cross-linkable material; and
a rate modifier for said polymerizable or cross-linkable material disposed on an outer surface of said inner container.

2. The applicator according to claim 1, wherein said outer container is flexible.

3. The applicator according to claim 1, wherein said outer container is a hollow, flexible cylinder.

4. The applicator according to claim 1, wherein said inner container is a frangible vial.

5. The applicator according to claim 4, wherein said frangible vial is made of glass or ceramic.

6. The applicator according to claim 1, wherein said rate modifier is in a non-contacting relationship with said polymerizable or cross-linkable material prior to opening of said inner container.

7. The applicator according to claim 1, wherein said rate modifier is lined or coated on said outer surface of said inner container.

8. The applicator according to claim 1, wherein said rate modifier is chemically bonded to said outer surface of said inner container.

9. The applicator according to claim 1, wherein said applicator is a syringe, a flexible cylinder, a tube, a pipette or an eye dropper.

10. The applicator according to claim 1, wherein said rate modifier comprises a detergent.

11. The applicator according to claim 1, wherein said rate modifier contains at least one member selected from the group consisting of a surfactant and an emulsifier.

12. The applicator according to claim 1, wherein said rate modifier is a polysorbate surfactant.

13. The applicator according to claim 1, wherein said rate modifier is a cationic surfactant.

14. The applicator according to claim 1, wherein said polymerizable or cross-linkable material is inorganic material or a combination of organic and inorganic materials.

15. The applicator according to claim 14, wherein said polymerizable or cross-linkable material is inorganic material selected from the group consisting of siloxanes, silicones, polysulfides, and polyphosphazenes.

16. The applicator according to claim 1, wherein said polymerizable or cross-linkable material is synthetic material selected from the group consisting of monomers that produce thermoplastic and thermoplastic elastomer polymers.

17. The applicator according to claim 16, wherein said polymers are selected from the group consisting of polyamides, nylon, polyvinylchloride, polycarbonates, polyethylene, polystyrene, polypropylene, fluorocarbon resins, polyurethane resins, acrylate resins and polyesters.

18. The applicator according to claim 1, wherein said polymerizable or cross-linkable material comprises 1,1-disubstituted ethylene monomer.

19. The applicator according to claim 18, wherein said monomer comprises an alpha-cyanoacrylate monomer.

20. The applicator according to claim 1, wherein said rate modifier is selected from the group consisting of alkylbenzyldimethylammonium chloride, tetrabutylammonium bromide, sodium tetradecyl sulfate, dodecyldimethyl(3-sulfopropyl)ammonium hydroxide, imidazole, tryptamine, urea, arginine, povidine, phosphines, triethyl phosphite, phosphonium salts, methyl gallate, ascorbic acid, tannic acid, sodium bisulfite, magnesium hydroxide, calcium sulfate, sodium silicate, thiourea, polysulfides, monensin, nonactin, calixarenes, polymeric epoxides, carbonates, cobalt napthenate, manganese acetylacetonate and phase transfer catalysts.

21. The applicator of claim 1, wherein said polymerizable or cross-linkable material is organic.

22. The applicator of claim 1, wherein said rate modifier is a catalyst.

23. The applicator of claim 1, wherein the polymerizable or cross-linkable material is biocompatible.

24. A method of making an applicator for dispensing a polymerizable or cross-linkable material, comprising:
sealing a polymerizable or cross-linkable material in an inner container;
applying a rate modifier for said polymerizable or cross-linkable material to an outer surface of said inner container; and
disposing said inner container within an outer container having dispensing means for dispensing said polymerizable or cross-linkable material from said applicator.

25. The method according to claim 24, wherein said sealing step comprises sealing said polymerizable or cross-linkable material in a frangible vial.

26. The method according to claim 24, wherein said applying step comprises coating or lining an entire surface of said outer surf ace of said inner container with said rate modifier.

27. The method according to claim 24, wherein said applying step comprises coating or lining only a part of said outer surface of said inner container with said rate modifier.

28. A method of applying a polymerizable or cross-linkable material to a substrate, comprising:
providing an applicator according to claim 1;
opening said inner container of said dispenser to contact said polymerizable or cross-linkable material with said rate modifier; and
dispensing said polymerizable or cross-linkable material from said outer container.

29. The method of claim 28, wherein said inner container is a frangible vial, and said opening step comprises breaking said frangible vial.

30. The method of claim 28, wherein said dispensing step comprises squeezing said outer container to dispense said polymerizable or cross-linkable material.
